(19) United States
(12) Patent Application Publication
(10) Pub. No.: US 2014/0351136 A1
(43) Pub. Date: Nov. 27, 2014

(54) SYSTEM FOR AUTHORIZING ELECTRONIC TRANSACTIONS AND A METHOD THEREOF

(71) Applicant: JPARSOF INVESTMENT CORPORATION, Sugar Land, TX (US)

(72) Inventors: Lalitha Kaleedhass, Missouri City, TX (US); Narayanaswamy Srikanthan, Missouri City, TX (US); Karthik Kaleedhass, Missouri City, MI (US)

(73) Assignee: JPARSOF INVESTMENT CORPORATION, Sugar Land, TX (US)

(21) Appl. No.: 14/285,230

(22) Filed: May 22, 2014

(30) Foreign Application Priority Data
May 23, 2013 (MY) PI 2013001912
Jul. 9, 2013 (MY) PI 2013002616

(51) Int. Cl. G06Q 20/40

(52) U.S. Cl. CPC G06Q 20/4014
USPC 705/44

(57) ABSTRACT

A system (100) and a method for authorizing electronic transactions have been disclosed. The system (100) includes a data storage and processing unit (102) and at least one computing device (104). The computing device (104) which is associated with at least one user facilitates in authentication of users involved in transactions for generation of notifications for the data storage and processing unit (102). The notification comprises information including specific or range bound values, names of parties involved in the transaction and the time limit for expiration of the notification. This notification is used by the data storage and processing unit (102) to allow a transaction if the transaction is within the bounds of the notification.

### FIELD OF THE INVENTION

The present invention relates to the field of identity assurance and prevention of fraud.

Specifically, the present invention is directed towards a system and a method for authorizing transactions by verifying identity of parties involved in the transaction.

### BACKGROUND OF THE INVENTION

Emerging Technologies in the information technology domain have contributed to make transactions between parties whether electronic or non-electronic easier and faster. These advances are obliviously a part of our lives and extensively used in the form of point of sales systems for retail commerce, e-commerce, e-banking, e-trading and the like.

However, these transaction systems are susceptible to attacks by fraudulent users who intend to compromise security of these systems. These attacks are seen in the form of identity thefts and fraudulent transactions. Hence, today fraud prevention is a prime area of focus for institutions worldwide to facilitate secure transactions between parties. Fraud prevention plays a very important role as it helps to build confidence in a transaction system.

Fraud prevention requires identity of an individual involved in a transaction to be assured to keep the integrity and overall confidence in the transaction system intact. If the transaction system is compromised it will lead to economic loss and impact the reputation of the entity facilitating the transaction. For example, a transaction with a financial institution such as a bank or credit institution requires the identity of the individual involved in the transaction to be assured else the institution's reputation, the sensitivity of the financial information and the individual's financial standing is compromised and as a result the entire financial system is compromised.

There were several attempts in the prior art for assuring identity of individuals participating in a transaction and for prevention of fraudulent transactions. The prior art transaction system require the identity of individuals participating in a transaction to be verified and assured at the time of initiation of a transaction. Thereby, an individual impersonating another individual, who is aware of all the procedures and techniques used for identity assurance check at the time of initiating the transaction, can successfully complete the transaction. This is because any successful initiation of the transaction after identity assurance results in successful completion of the transactions as there aren't adequate identity assurance checks which take place while a transaction is being carried out.

The prior art also includes automated fraud prevention systems which are used in transactions to call back/verify back/sending a message (SMS) for verifying details of a transaction in real-time with an individual who initiated the transaction. These systems generate a verification request either each time or on detection of fraudulent behavior or unusual behavior in a transaction. For example, in case of credit card payment, the bank or the financial institution or the credit card organization will call back the user of the card to validate whether the transaction is initiated by a legitimate individual.

However, the fraud prevention calls cause a lot of inconvenience to individuals as they need to verify themselves and confirm details of the transaction to the financial institution to allow the transaction to be authorized. Even though these checks are conducted in the middle of the transaction, these calls do not guarantee hundred percent identity assurance as the checks that are carried out at this stage are always designed with flexibility, as the goal is not to impact the speed of the transactions which may be carried out by authentic individuals. Thus, this constraint enables the impersonating individual to successfully complete the transaction as he is aware of the methods used in verification. Therefore, the conventional fraud prevention systems are limited in function and constrained by the current implementation platform.

Still further, these fraud prevention systems require transaction authorization to be kept on hold until the verification request is confirmed by the user. Even though this technique partly achieves the objective of identity assurance it adds significant delays to the transactions increasing the failure rate of the transaction initiated by a genuine user as there are time-outs set for such response, wherein if a request was not received within a specific time frame the transaction is denied. The communication between the entity facilitating the transaction and the initiator of the transaction can fail due to various practical factors such as failure of a communication device, for example, an individual's mobile computing device may be out of coverage area or the computing device may be out of battery.

Secondly, carrying out verification in between of a transaction requires significant changes to the current computing infrastructure where the transactions takes place, as the procedure to pause the transaction, pending verification from the individual, needs to be added to the process. Such changes may require regulatory approvals in many countries and might impact the key performance indicators of the institutions having customer satisfaction as one of their goals.

Furthermore, in the absence of adequate identity assurance checks and the consumer friendly laws in various countries, individuals may misuse the friendly environment to repudiate themselves and disown transactions resulting in burden to the institutions where the transactions had taken place as these institutions need to rollback the transactions.

There is therefore a need for an identity assurance and fraud prevention system which includes one or more of the following aspects:
ensures fool proof identity checks;
ensures non-repudiation and thereby reduces overheads faced by institutions/entity involved in rollback of transactions;
provides fool proof safety and security without compromising flexibility offered to individuals; and
facilitates authorization of transactions without requiring any infrastructural changes in the established procedures followed by the current transaction systems.

### SUMMARY OF THE INVENTION

In accordance with this invention, there is provided a system for authorizing transactions, the system comprising a data processing and storage unit and at least one computing device co-operating with the data processing and storage unit over a network, wherein
the computing device is associated with at least one user, wherein the user is associated with an identification code, the computing device prompts for input of at least one authentication code from the user and facilitates generation of a notification if authentication code is verified and transmits the notification along with the identification code to the data processing and storage unit;
the data processing and storage unit is associated with at least one entity, the data processing and storage unit including a processing unit and a repository coupled to the processing unit, wherein the processing unit receives at least one notification and the identification code from a user associated with a computing device for at least one entity and stores the notification in the repository for the user; and
the processing unit compares details of an actual transaction with the stored notification in the repository for the user and authorizes a transaction in the event that the transaction is within the bounds of the notification and sends a confirmation message to the user.

Typically, the authentication code is at least one code selected from the group consisting of a biometric sample, a secret code, a single factor authentication code, and a multifactor authentication code.

Preferably, the biometric sample is selected from the group consisting of a voice print, a fingerprint, a retinal image, an iris image, and a facial image.

Further, the notification comprises information including specific/range based values pertaining to a transaction, monetary value/range bound monetary value for a transaction, currency details, credentials and geographical data of entities involved in the transaction, and time-limit associated with the notification.

Still further, the notification is generated for transactions at events including prior to initiation of a transaction, at initiation of a transaction, during a transaction and before completion of a transaction.

In addition, the computing device transmits the notification to the data storage and processing unit using communication techniques including Interactive Voice response, Touch Tone response, voice over data, and voice call.

Furthermore, the processing unit sends a confirmation of delivery to the computing device.

Additionally, the processing unit validates the authenticity of the notification and the identification code before storing in the repository.

In accordance with this invention, the processing unit updates the status of the notification on completion of an actual transaction, wherein the status includes details selected from the group consisting of the entity against which the notification is used; balance amount available in the notification and expiration details of the notification.

Also, the processing unit updates status of the transaction on completion of an actual transaction, wherein the status is selected from the group consisting of hold, cleared and posted.

Typically, the computing device facilitates registration of a user, wherein the registration includes facilitating selection of at least one account associated with at least one entity; accepting a sample authentication code from the user, prompting the user to select a preferred storage location for the sample authentication code for future verification and assigning an identification code to the user, wherein the preferred storage location includes in a memory included in the computing device, the repository of the data processing and storage unit and a third party storage and verification server accessible to the computing device and the data processing and storage unit.

Preferably, the computing device verifies the authentication code with a sample stored therein to allow transmission of the notification to the data processing and storage unit. Alternatively, the computing device transmits the authentication code to the data processing and storage unit, wherein the repository stores a sample of the authentication code and the processing unit verifies the authentication code with the sample and transmits verification result to the computing device. Still further, the computing device transmits the authentication code to the third party storage and verification server, wherein the third party storage and verification server verifies the authentication code with an authentication code sample stored therein and transmits verification result to the computing device.

Typically, the processing unit generates a reverse notification for a user associated with the computing device in the event that no stored notification is retrieved from the repository for an actual transaction.

In addition, the processing unit transmits the reverse notification to a computing device using communication channels selected from the group consisting of short message service (SMS), multimedia messaging service (MMS), direct messaging protocol and Email.

Furthermore, the computing device prompts a user to provide an authentication code for verification to approve a reverse transaction.

The present invention envisages a computing device, the computing device comprising: a processor; and a memory co-operating with the processor,
wherein the memory hosting a transaction application that when executed by the processor performs operations including: prompting for an input of at least one authentication code from a user; facilitating generation of a notification if authentication code is verified; transmitting the notification for authorizing a transaction; and receiving a confirmation and status of the transaction and the notification on completion of an actual transaction.

Typically, the processor initiates an interface for the transaction application, wherein the interface is at least for: initiating a prompt to a user to login to the transaction application; registering at least one account associated with at least one entity with the transaction application; input of at least one authentication code from the user; selecting storage preference of the authentication code; capturing at least one authentication code from the user; and verifying the authentication code to confirm registration.

Preferably, the interface is at least for: initiating a prompt to a user for selecting at least one entity for generation of a notification; composing a notification by entering information including credentials and geographical data of the parties involved in the transaction, specific or range based value for the transaction and time-limit associated with the notification; performing authentication code verification; scrambling and compressing the composed notification for transmission on successful verification of the authentication code; and displaying a notification delivery confirmation to the user.

Further, the interface is at least for: checking the status of the notification including if the notification has been received by the entity; the entity against which the notification is used; balance amount available in the notification and expiration details of the notification.

Still further, the authentication code is at least one code selected from the group consisting of a biometric sample, a secret code, a single factor authentication code, and a multifactor authentication code.

Furthermore, the computing device includes at least one biometric-capturing means including a microphone, a biometric scanner and a biometric sensor.

In addition, the computing device receives a reverse notification for verification of details of an actual transaction.

Preferably, the computing device performs authentication code verification for a user in response to the reverse notification to facilitate a verified user to approve a transaction.

According to the invention, there is provided a method for authorizing a transaction, the method comprising the following steps:
verifying at least one authentication code associated with a user;
facilitating a verified user to generate a notification for conducting a transaction using a computing device;
transmitting the notification along with an identification code to a data storage and processing unit;
storing the notification corresponding to the identification code for a validated user in a repository at the data storage and processing unit;
verifying an actual transaction based on the notification for a user at the data storage and processing unit;
authorizing the actual transaction in the event that the actual transaction is within the bounds of the notification; and
sending a confirmation message to the user.

Typically, the step of verifying at least one authentication code associated with a user includes accepting an authentication code selected from the group consisting of a biometric sample, a secret code, a single factor authentication code, and a multifactor authentication code.

Preferably, the step of facilitating a verified user to generate a notification includes prompting the verified user to enter credentials and geographical data of parties participating in the transaction; specific or range based value for the transaction; time-limit associated with the notification; and compressing and scrambling the composed notification for transmission.

Further, the step of storing the notification corresponding to the identification code includes sending a delivery receipt confirmation message back to the computing device for displaying to the corresponding user.

Still further, the step of verifying an actual transaction based on the notification includes the following steps:
comparing the details of the notification with the details of the actual transaction to verify if actual transaction is within the bounds of the notification; and
marking the notification as used/partly used in the repository and updating the status of the transaction.

Additionally, the step of verifying an actual transaction includes:
generating a reverse notification at the data processing and storage unit in the event that no stored notification is retrieved;
transmitting the reverse notification to a user on the corresponding computing device;
conducting authentication code verification for the user; and
enabling the user to approve a transaction if the authentication code is verified.

Furthermore, the method includes registration of users for facilitating authorization of transactions, the method comprising the following steps:
prompting a user to select at least one account associated with at least one entity;
prompting for input of at least one sample authentication code from the user;
prompting the user to select at least one storage preference of the sample authentication code, wherein the storage preference is selected from the group consisting of in a memory included in the computing device, in the repository of the data processing and storage unit, and a third party storage and verification server accessible to the computing device and the data processing and storage unit.
capturing at least one authentication code from the user; and
verifying the authentication code with the sample to confirm registration and assign an identification code to the user.

In addition, the step of verifying at least one authentication code associated with a user includes verifying the authentication code with a sample stored in the computing device. Alternatively, the step of verifying at least one authentication code associated with a user includes verifying the authentication code with a sample stored in the repository of the data processing and storage unit and transmitting the verification result to the computing device or verifying at least one authentication code associated with a user includes verifying the authentication code with a sample stored in a third party storage and verification server and transmitting the verification result to the computing device.

### BRIEF DESCRIPTION OF THE ACCOMPANYING DRAWINGS

The drawings constitute part of this specification and include an exemplary or preferred embodiment of the invention, which may be embodied in various forms. It should be understood, however, the disclosed preferred embodiments are merely exemplary of the invention. Therefore, the figures disclosed herein are not to be interpreted as limiting, but merely as the basis for the claim and for teaching one skilled in the art of the invention.

In the appended drawings:

FIG. 1 discloses a schematic diagram of the system for authorizing transactions in accordance with this invention;

FIG. 2 is a flowchart showing the steps involved in authorizing transactions in accordance with this invention; and

FIG. 3 is a flowchart showing the steps involved in generation of a reverse notification for authorizing a transaction.

### DETAILED DESCRIPTION

Detailed descriptions of preferred embodiments of the present invention are disclosed herein. It should be understood, however, that the embodiments are merely exemplary of the present invention, which may be embodied in various forms. Therefore, the details disclosed herein are not to be interpreted as limiting, but merely as the basis for the claim and for teaching one skilled in the art of the invention.

The following detailed description of the preferred embodiments will now be described in accordance with the attached drawings, either individually or in combination.

By way of definition, the term ‘computing device’ in this specification relates to a wired or wireless device which is capable of transmitting and receiving information over a network. The computing device is capable of identifying an individual using voice as a biometric. Alternatively, the computing device is built-in with a biometric scanner or a biometric sensor to identify an individual by capturing the individual's biometric print including a voice print, a fingerprint, a retinal image, an iris image or a facial image. The computing device may include telephones, mobile phones, smart phones, tablets, personal device assistance, desktops, workstations, laptops, notebooks, and other types of devices with computing functionality.

The term ‘actual transaction’ in this specification refers to transaction that is being executed between one or more individuals or organizations in real-time.

The term ‘authentication code’ in this specification relates to an identifier selected by the user which is used by a system to verify the user and ascertain his/her true identity. The authentication code includes at least one or a combination of a password, a biometric sample, a multifactor authentication code, a doodle which can be selected by a user to securely login and use the system.

The term ‘credentials and geographical data’ in this specification refers to names of the parties involved in a transaction and the geographic location of the parties.

The term ‘entity’ in this specification relates to an institution which regulates a transaction. For instance, an entity will be a bank, a credit union, an insurance institution, a financial institution or other corporations which facilitate dealings between two parties.

The term ‘identification code’ in this specification relates to a sequence of numbers or alphabets or combinations of numbers and alphabets which is used to uniquely identify an individual/user.

The term ‘notification’ in this specification refers to one or more messages, a group of characters and/or words, a signal or a group of instructions containing information relating to a transaction.

The term ‘network’ in this specification includes computer networks, telecommunication networks, radio networks, wireless networks, dependent networks, internal networks/Local Area Network (LAN), gateway networks, tunneled networks over other networks, virtual private networks, shared networks, public networks and other similar networks that provide the facility to transport and receive data. The term network also includes sub-networks for successful transport of data across all the parties in the transaction. It may further also include converters such as analog to digital or digital to analog for successful transport of data.

The term ‘transaction’ in this specification refers to one or more activities involving financial or non-financial dealings between one or more individuals or organizations. The transaction can be carried out across various jurisdictions and the parties involved in the transaction can be in the same or different jurisdictions.

The conventional identity assurance and fraud prevention techniques do not provide fool-proof security and safety to transaction systems as they are constrained to provide quick completion of a transaction along with flexibility and convenience to users. Moreover, the conventional techniques require infrastructural changes in the flow of the transaction systems in order to incorporate additional checks and verification steps for non-repudiation and prevention of fraud.

These drawbacks of the conventional systems led the present invention to envisage a system for authorizing transactions. The proposed system ensures fool proof identity checks without compromising flexibility offered to users and without requiring any infrastructural changes in the flow of the existing transaction systems.

In accordance with this invention, the system for authorizing transaction works in conjunction with existing transaction facilitating systems to perform identity assurance as well as to prevent fraudulent transactions. To achieve the above objectives the system comprises a data processing and storage unit and at least one computing device co-operating with the data processing and storage unit over a network.

The data processing and storage unit is associated with at least one entity to facilitate in authorizing transaction for that entity. And, the computing device is associated with at least one user account and enables the data processing and storage unit to identify the user account with a unique identification code.

In accordance with one aspect of the present invention, for prevention of fraudulent transactions the proposed system envisages generation of a notification using the computing device, wherein the notification is used by the data processing and storage unit for authorization of a transaction. The system provides users with the flexibility to generate the notification prior to initiation of a transaction, in midst of the transaction or before the transaction is finalized. The notification is a preemption message to notify the entity of a transaction.

In accordance with this invention, the notification includes details including specific or range bound values for example monetary values, names of parties involved in the transaction, geographical location of the party with whom the transaction will be conducted, time-limit after which the notification will expire. Thus, when an actual transaction takes place, the data processing and storage unit compares the details of the notification with the details of the actual transaction. If the details of the actual transaction fall within the bound of the notification the data processing and storage unit authorizes the transaction and informs the entity associated with the transaction to approve it. In this manner, the user is provided with the flexibility to verify a transaction for its successful and secure execution without requiring any infrastructural changes to the existing transaction system workflow.

In the event that no notification is received by the data processing and storage unit when an actual transaction is being conducted then the data processing and storage unit generates a reverse notification for the user on his/her computing device for verifying the details of the transaction.

In accordance with another aspect of the present invention, the reverse notification from the data processing and storage unit is sent using a short message service (SMS) over the cellular networks, a multimedia messaging service (MMS) over cellular or wireless networks and also through a direct messaging protocol to the user's computing device. Alternatively, the reverse notification is also sent to the user's mail box such as E-Mail and the gateway computer or server which is involved in the process of delivery of the notification generates a confirmation message back to the data processing and storage unit informing the user of the successful delivery of the notification.

In accordance with another aspect of the present invention, the proposed system performs identity assurance to ensure that the notification being generated or the reverse notification is being approved only by a legitimate user. The identify assurance is carried out by the computing device using at least one authentication code including biometric based features, known secret codes or with the use of single factor, two factor or multi factor authentication, with the authentication code used to identify users being stored either in the computing device itself, in a repository at the data processing and storage unit or in a third party storage and verification server which is in communication with the computing device. The computing device also includes techniques involved in extraction of the stored authentication code and its verification.

The system provides users with the flexibility to choose the location of storage of the authentication code to be used for future verification that is, in the computing device itself, in the data processing and storage unit, in the third party storage and verification server. This system ensures that the authentication code is stored in a secure manner to prevent unauthorized use, tampering or extraction of the authentication code.

Further, the computing device facilitates in registration of users and management of multiple user accounts or identifiers for a single or multiple entities on a central data processing and storage unit.

In addition, the computing device activates or registers the users for the specific accounts or identifiers and verifies that the user is able to successfully notify the data processing and storage unit and the data processing and storage unit can successfully receive the notification from the user. This check ensures that the flow or processing of actual transactions is not disrupted by failure of receiving the notification by the data processing and storage unit.

In accordance with yet another aspect of this invention, the data processing and storage unit maps the notification sent by the users against actual transactions and updates the status of the notification. The status updates reflect information including whether the notification has been received by the data processing and storage unit, whether the notification has been used by the data processing and storage unit against an actual transaction, and if there is any balance available on the notification in terms of amount or time limit. The data processing and storage unit further classifies the transactions as hold, cleared and/or posted. The system includes provision by virtue of which classification of the transaction can be changed by other parties involved in the transaction such as suppliers or merchants. These status updates and classification can be accessed and viewed by users using their computing devices.

In accordance with still another aspect of this invention, the notification generated using the computing device is transmitted to the data processing and storage unit using interactive voice response, voice call, touch tone response and voice of data. This involves users contacting the entity via the data processing and storage unit, identifying themselves using the identification code and authentication code and generating a notification for a transaction on successful authentication.

Thereby, the proposed system ensures fool proof identity checks and non-repudiation without compromising on the flexibility offered to users. The system does not alter the workflow of existing transaction systems for authorization of transactions.

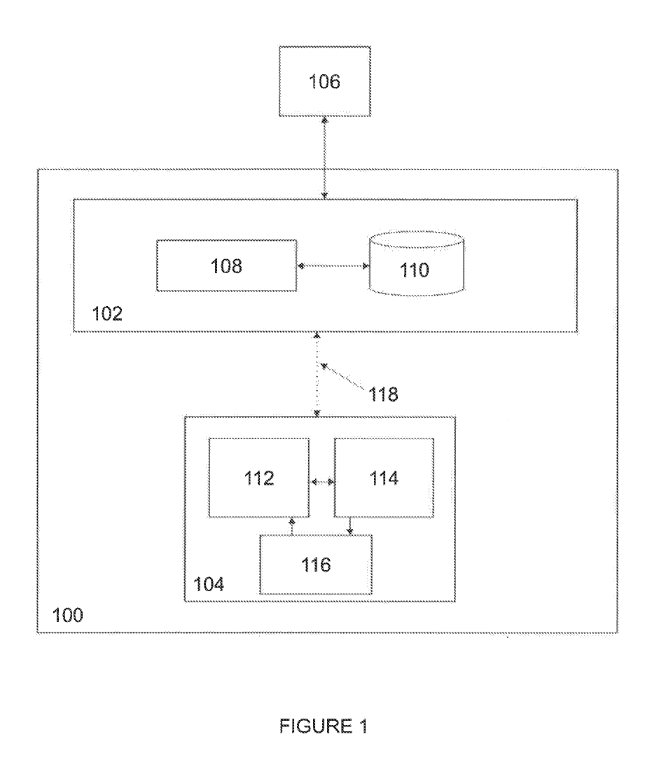

The present invention will now described with reference to the accompanying drawings. Referring to FIG. 1, which discloses a block diagram of the system (100) for authorizing electronic transactions. The system (100) includes two main components which are a data processing and storage unit (102) and at least one computing device (104), which communicates with the data processing and storage unit (102) over a network (118).

The computing device (104) is associated with at least one user, wherein the user is associated with an identification code. The computing device (104) comprises a processor (112); a memory (114) co-operating with the processor (112) and a data capturing unit (116) which is communicably coupled to the processor (112) and the memory (114). The memory (114) hosts a transaction application. The transaction application enables the computing device (104) to communicate with the data processing and storage unit (102) to facilitate in assuring the identity of the user and authorizing transactions.

The processor (112) with the aid of the transaction application initiates an interactive interface for the users. The interface displays a plurality of menu items, wherein each menu item opens a discrete cascading sub-interface for the user. The various menu items available to the user include registration, compose notification and check status of notifications and transaction.

Thus, using the interface of the transaction application the users can perform the following operations: register themselves, send and receive notifications, confirm the notifications, identify themselves using at least one authentication code, scramble the notification and/or to compress the notification and also check the status of the notification.

The registration sub-interface enables users to register at least one account associated with at least one entity with the data processing and storage unit (102). During registration, the processor (112) prompts the user to provide an authentication code using the data capturing unit (116) for uniquely identifying the user. The authentication code may be but is not limited to, at least one or a combination of the following: a biometric sample, a secret code, a single factor authentication code, and a multifactor authentication code. Preferably, the processor (112) prompts the user to provide a biometric sample for registration.

The data capturing unit (116) maybe but not limited to biometric sensor and/or scanner to enable the user to provide the biometric sample including a finger print, a retinal image, an iris image, facial image and the like. Alternatively, the data capturing unit (116) includes a microphone to enable users to provide a voice based biometric sample.

Further, on capturing the biometric sample, the processor (112) prompts the user to select the location in which the biometric sample must be stored. The user can store the biometric sample either in the memory (114) of the computing device (104) itself, in a repository (110) hosted in the data processing and storage unit (102) or in a third party storage server. The biometric sample is then stored in the selected location and is further verified for confirming the registration. On successful completion of the registration the data processing and storage unit (102) is notified which then assigns a unique identification code to the user. The unique identification code is assigned for a combination of a particular user and one or more entities selected by the user. The unique identification code and the selected authentication code is used by the user to login to the transaction application.

The compose notification sub-interface of the transaction application enables the computing device (104) to prompt the user to select at least one entity (106) registered by the user or enroll a new entity for which the user wants to generate a notification. On selection of the entity, the user is further prompted by the processor (112) to compose the notification. The compose notification interface prompts the user to enter at least credentials and geographical data of the parties which will be involved in the transaction, a time limit for which the notification is valid, and a monetary value (if any) associated with the transaction.

In accordance with this invention, while composing the notification the user may enter names of parties involved in the transaction including the name of the person initiating the transaction, name of the person participating in the transaction and names of one or more entities that will facilitate the transaction. The names of the parties can be specified in the exact form matching exactly the names of the parties involved in the transaction or can be specified using the subset of letters from the names of the parties, for example, “KARSOF” could be specified to match “KARSOF AIRLINES”. The names of the parties in the notification can be also specified using an organization registration number or any number which precisely identifies the parties involved in the transaction. The company/organization number can be a sequence of characters or numerals or both issued by a registration authority in a specific jurisdiction. Further, the geographical location of the parties in the notification can be identified by specifying the details of the location of the parties such as City, County, Street Name, Zip Code or the Country or the Continent.

Still further, the time limit includes one or more value deciding the expiration of the notification and such value can be expressed in the form of time including seconds, minutes, hours, days, months and years. In addition, the time limit can be specified using one or more values of specific date with a sequence of day, month and year value either in numerals or in characters for example, to identify a month either “January” or numeral “1” can be used. The specific date can be current date or future date. The time limit can be also specified using one or more values representing the recurring occurrence of the specific time period represented in the time units such as seconds, minutes, days, months and years. Such recurring value can be also be paired with one or more values identifying the start and end period, which can be expressed using a specific value containing date with the sequence of day, month and year and such value can be representing a future or current time period.

Once the notification is composed the processor (112) carries out biometric based verification wherein the user is prompted to provide his/her registered biometric feature. Depending on the storage location selected for storing the sample biometric the biometric verification is conducted. If the sample biometric is stored in the memory (114) then the processor (112) conducts the biometric verification by comparing the biometric feature input by the user with the stored sample. The processor extracts the sample stored therein to conduct the verification. In the event, that the sample biometric is stored in the repository (110) or a third party storage server, the data processing and storage unit (102) conducts the verification and sends the verification results to the computing device (104). In accordance with this invention, the verification can be also conducted using other authentication techniques including a secret code, a single factor authentication code, and a multifactor authentication code. Additionally, the verification can be conducted using a combination of two or more authentication techniques.

The processor (112) transmits the composed notification to the data processing and storage unit (102) on successful verification. The processor (112) scrambles and compresses the notification for its prompt and secure transmission. The processor (112) also packages the user identification code in the notification so that the data processing and storage unit (102) can easily identify the user generating the notification.

The purpose of scrambling is to reduce the size of the notification so that the information reaches the intended destination quickly and also to prevent unauthorized use or tempering of the notification. Scrambling can be implemented using a computer implemented method executed by one or more processes from instructions from a program that is stored in one or more storage devices embedded or external to the computing device (104). Such scrambling can be also implemented in a separate process or method part of the device or external to the computing device (104).

The user can compose and send the notification to the data processing and storage unit (102) either via touch tone response, interactive voice response or over a voice call. Once the notification reaches the data processing and storage unit (102) the client device (104) displays a confirmation of delivery for the user.

The data processing and storage unit (102) is associated with at least one entity (106) for facilitating in authorizing transactions. The data processing and storage unit (102) includes a processing unit (108) and a repository (110) coupled to the processing unit (108), wherein the processing unit (108) receives the generated notification for at least one entity and the user's unique identification code from a user associated with a computing device (104). The processing unit (108) verifies if the received identification code corresponding to a user is valid and whether the notification message is tampered.

If both the code and notification are proper the processing unit (108) stores the notification in the repository (108) for the user.

When an actual transaction takes place the entity notifies the processing unit (108). The processing unit (108) then extracts a stored notification for that user and compares details of an actual transaction with the stored notification in the repository (110) for the user and authorizes a transaction in the event that the actual transaction is within the bounds of the notification and generates a confirmation for the entity.

For instance, if the user had sent a notification which included the following details, name of the party: Y, name of the transaction initiator: X, name of the entity: Z, location: ABC, monetary value: $250 and time-limit: 30 minutes. Thus, when an actual transaction is initiated the processing unit (108) checks if the name of the party includes Y, name of the transaction initiator includes X, name of the entity includes Z, whether the geographic location is ABC and the monetary value is less than or equal to $250. The processing unit (108) also checks if the notification against which the actual transaction is being mapped is valid i.e. in this case the actual transaction is taking place within 30 minutes from the time the notification was received at the data processing and storage unit (102).

The transactions that are authorized and mapped to notifications are stored and classified into various classifications such as hold, cleared and/or posted by the processing unit (108). In addition, the system (100) enables the classification of the transaction to be changed by other parties involved in the transaction such as suppliers or merchants. The system (100) provides an interface to the other parties, using which they can check the status and classification of the actual transactions they are associated them and update them accordingly.

The processing unit (108) also updates the status of the notification to indicate whether it has been received by the entity, has been used by the entity against the actual transaction, and if there is any balance available in case the amount is based on range bounded on a maximum value or time limit.

The transaction classification and the notification status updates can be retrieved by the users using their computing device (104) by selection of the check status sub-interface provided by the transaction application. Thus, the transaction application provides the facility to the users in their computing device, to check whether status of the notification sent by the users to various entity with the statuses including whether the notification has been used by the entity against the actual transaction, and if there is any balance available in the notification based on range bounded on a maximum value or time limit.

Furthermore, the system (100) gives users the flexibility to generate the notifications before initiating an actual transaction, in midst of carrying out an actual transaction or before finalizing an actual transaction. In the event that no stored notification is retrieved or any new notification is received by the processing unit (108) when an actual transaction is initiated, the processing unit (108) then generates a reverse notification for the user. The computing device (104) receives the reverse notification from the data processing and storage unit (102) through short message service (SMS) over the cellular networks, multimedia messaging service (MMS) over cellular or wireless networks, through a direct messaging protocol and email.

In accordance with this invention, the gateway computer or server which is involved in the process of delivery of the reverse notification to the user also provides a confirmation message back to the processing unit (108) to ensure that the user has received the notification. On receipt of the reverse notification the computing device (104) prompts the user to provide the selected authentication code for verification. On successful verification the user can confirm or reject the reverse notification. Accordingly, the actual transaction terminates successfully or ends in failure.

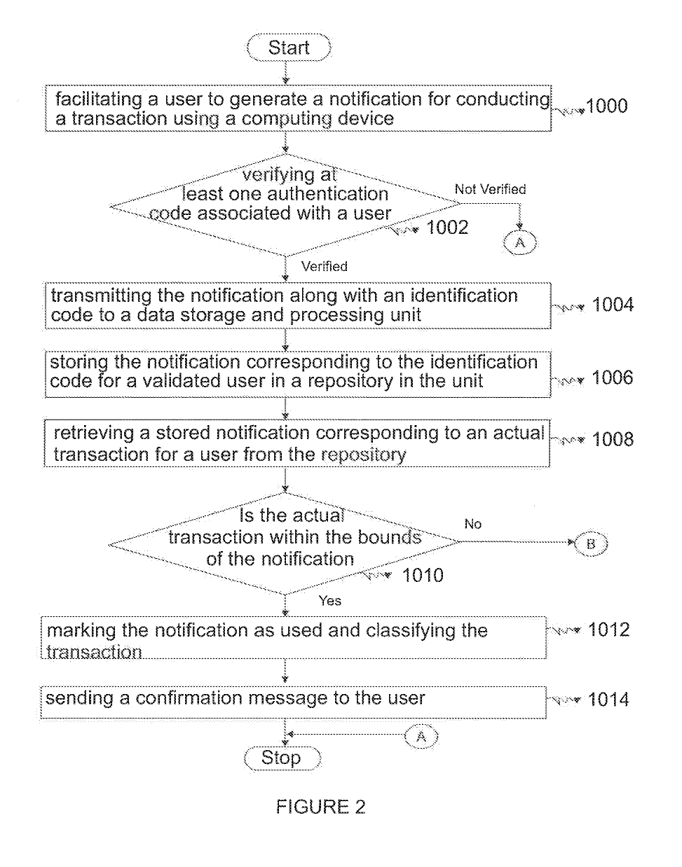

The present invention envisages a method for authorizing electronic transactions, the method comprising the following steps as seen in FIG. 2:
facilitating a user to generate a notification for conducting a transaction using a computing device (1000);
verifying at least one authentication code associated with a user (1002);
transmitting the notification along with an identification code to a data storage and processing unit if the authentication code has been verified (1004);
storing the notification corresponding to the identification code for a validated user in a repository at the data storage and processing unit (1006);
retrieving a stored notification corresponding to an actual transaction for the user from the repository (1008);
verifying the actual transaction based on the notification for a user at the data storage and processing unit (1010);
authorizing the actual transaction in the event that the actual transaction is within the bounds of the notification, marking the notification as used and classifying the transaction (1012); and
sending a confirmation message to the user (1014).

Typically, the step of verifying at least one authentication code associated with a user includes accepting an authentication code selected from the group consisting of a biometric sample, a secret code, a single factor authentication code, and a multifactor authentication code.

Preferably, the step of facilitating a verified user to generate a notification includes prompting the verified user to enter credentials and geographical data of parties participating in the transaction; specific or range based value for the transaction; time-limit associated with the notification; and compressing and scrambling the composed notification for transmission.

Further, the step of storing the notification corresponding to the identification code includes sending a delivery receipt confirmation message back to the computing device for displaying to the corresponding user.

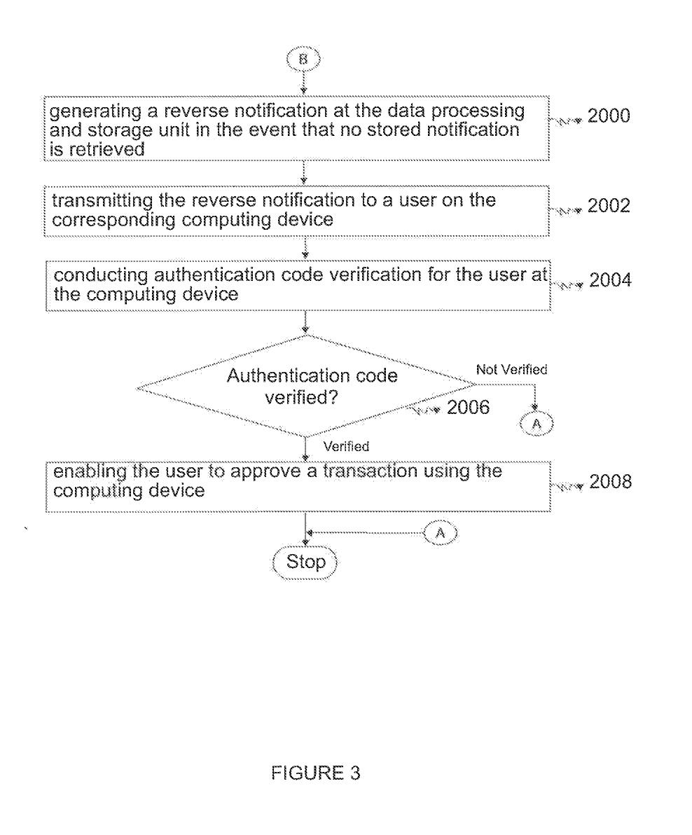

Still further, the present invention envisages a method for authorizing a transaction in case no stored notification can be mapped to an actual transaction as seen in FIG. 3:
generating a reverse notification at the data processing and storage unit in the event that no stored notification is retrieved (2000);
transmitting the reverse notification to a user on the corresponding computing device (2002);
conducting authentication code verification for the user (2004); and
enabling the user to approve a transaction if the authentication code is verified (2006).

Furthermore, the method includes registration of users for facilitating authorization of transactions, the method comprising the following steps:
prompting a user to select at least one account associated with at least one entity;
prompting for input of at least one sample authentication code from the user;
prompting the user to select at least one storage preference of the sample authentication code, wherein the storage preference is selected from the group consisting of in a memory included in the computing device, in the repository of the data processing and storage unit, and a third party storage and verification server accessible to the computing device and the data processing and storage unit.
capturing at least one authentication code from the user; and
verifying the authentication code with the sample to confirm registration and assign an identification code to the user.

In addition, the step of verifying at least one authentication code associated with a user includes verifying the authentication code with a sample stored in the computing device. Alternatively, the step of verifying at least one authentication code associated with a user includes verifying the authentication code with a sample stored in the repository of the data processing and storage unit and transmitting the verification result to the computing device or verifying the authentication code with a sample stored in a third party storage and verification server and transmitting the verification result to the computing device.

It should be appreciated that the example apparatus represents only one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments of the present invention.

Unless contrary to physical possibility, the inventors envision, the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

1. A system for authorizing electronic transactions over a network, comprising a data processing and storage unit (102) and at least one computing device co-operating with said data processing and storage unit over a network wherein;
said computing device is associated with at least one user, wherein the user is associated with an identification code, said computing device prompts for an input of at least one authentication code from the user and facilitates generation of a notification if authentication code is verified and transmits said notification along with said identification code to said data processing and storage unit;
said data processing and storage unit associated with at least one entity, said data processing and storage unit includes a processing unit and a repository coupled to said processing unit, wherein said processing unit receives at least one notification and said identification code from a user associated with a computing device for at least one entity and stores said notification in said repository for the user; and
said processing unit compares details of an actual transaction with the stored notification in said repository for the user and authorizes a transaction in the event that said transaction is within the bounds of said notification and sends a confirmation message to the user.

2. The system as claimed in claim 1, wherein said authentication code is at least one of a biometric sample, a secret code, a single factor authentication code, and a multifactor authentication code.

3. The system (100) as claimed in claim 2, wherein said biometric sample is at least one of a voice print, a fingerprint, a retinal image, an iris image, and a facial image.

4. The system as claimed in claim 1, wherein said notification is a preemption message to notify said entity of a transaction.

5. The system as claimed in claim 4, wherein said notification comprises information including specific/range based values pertaining to a transaction, monetary value/range bound monetary value for a transaction, currency details, credentials and geographical data of entities involved in the transaction, and time-limit associated with said notification.

6. The system as claimed in claim 1, wherein said notification is generated for transactions at events including prior to initiation of a transaction, at initiation of a transaction, during a transaction and before completion of a transaction.

7. The system as claimed in claim 1, wherein said computing device transmits said notification to said data storage and processing unit using communication techniques including Interactive Voice response, Touch Tone response, voice over data, and voice call.

8. The system as claimed in claim 1, wherein said processing unit sends a confirmation of delivery to said computing device.

9. The system as claimed in claim 1, wherein said processing unit validates the authenticity of said notification and said identification code before storing in said repository.

10. The system as claimed in claim 1, wherein said processing unit updates the status of said notification on completion of an actual transaction, wherein said status includes details from at least one of the entity against which the notification is used; balance amount available in the notification and expiration details of the notification.

11. The system as claimed in claim 1, wherein said processing unit updates status of said transaction on completion of an actual transaction, wherein said status is at least one of hold, cleared and posted.

12. The system as claimed in claim 1, wherein said computing device facilitates registration of a user, wherein said registration includes facilitating selection of at least one account associated with at least one entity; accepting a sample authentication code from the user, prompting the user to select a preferred storage location for said sample authentication code for future verification and assigning an identification code to the user, wherein said preferred storage location includes in a memory included in said computing device, said repository of said data processing and storage unit and a third party storage and verification server accessible to said computing device and said data processing and storage unit.

13. The system as claimed in claim 1, wherein said computing device verifies said authentication code with a sample stored therein to allow transmission of said notification to said data processing and storage unit.

14. The system as claimed in claim 1, wherein said computing device transmits said authentication code to said data processing and storage unit, wherein said repository stores a sample of said authentication code and said processing unit verifies said authentication code with said sample and transmits verification result to said computing device.

15. The system as claimed in claim 1, wherein said computing device transmits said authentication code to said third party storage and verification server, wherein said third party storage and verification server verifies said authentication code with an authentication code sample stored therein and transmits verification result to said computing device.

16. The system as claimed in claim 1, wherein said processing unit generates a reverse notification for a user associated with said computing device in the event that no stored notification is retrieved from said repository for an actual transaction.

17. The system as claimed in claim 16, wherein said processing unit (108) transmits said reverse notification to a computing device (104) using communication channels from at least one of short message service (SMS), multimedia messaging service (MMS), direct messaging protocol and Email.

18. The system as claimed in claim 16, wherein said computing device prompts a user to provide an authentication code for verification to approve a reverse transaction.

19. A computing device, comprising: a processor; a memory co-operating with the processor and a data capturing unit co-operating with said memory and said processor,
wherein said memory (114) hosting a transaction application that when executed by said processor performs operations including: prompting for an input of at least one authentication code from a user using said data capturing unit; facilitating generation of a notification if authentication code is verified; transmitting said notification for authorizing a transaction; and receiving a confirmation and status of the transaction and said notification on completion of an actual transaction, wherein said notification is a preemption message to notify said entity of a transaction.

20. The computing device of claim 19, wherein said processor initiates an interface for said transaction application, wherein said interface is at least for: initiating a prompt to a user to login to the transaction application; registering at least one account associated with at least one entity with said transaction application; input of at least one authentication code from the user through said data capturing unit; selecting storage preference of said authentication code; capturing at least one authentication code from the user via said data capturing unit; and verifying said authentication code to confirm registration.

21. The computing device of claim 19, wherein said interface is at least for: initiating a prompt to a user for selecting at least one entity for generation of a notification; composing a notification by entering information including credentials and geographical data of the parties involved in the transaction, specific or range based value for the transaction and time-limit associated with the notification; performing authentication code verification; scrambling and compressing the composed notification for transmission on successful verification of the authentication code; and displaying a notification delivery confirmation to the user.

22. The computing device of claim 19, wherein said interface is at least for: checking the status of the notification including if the notification has been received by the entity; the entity against which the notification is used; balance amount available in the notification and expiration details of the notification.

23. The computing device of claim 19, wherein said authentication is at least one of a biometric sample, a secret code, a single factor authentication code, and a multifactor authentication code.

24. The computing device of claim 19, wherein said data capturing unit is at least one of a microphone, a biometric scanner and a biometric sensor.

25. The computing device of claim 19, wherein said computing device receives a reverse notification for verification of details of an actual transaction.

26. The computing device of claim 25, wherein said computing device performs authentication code verification for a user in response to said reverse notification to facilitate a verified user to approve a transaction.

27. A method for authorizing electronic transactions over a network, comprising:
verifying at least one authentication code associated with a user;
facilitating a verified user to generate a notification for conducting a transaction using a computing device;
transmitting said notification along with an identification code to a data storage and processing unit;
storing said notification corresponding to said identification code for a validated user in a repository at the data storage and processing unit;
verifying an actual transaction based on the notification for a user at the data storage and processing unit;
authorizing said actual transaction in the event that said actual transaction is within the bounds of said notification; and
sending a confirmation message to the user.

28. The method as claimed in claim 27, wherein the step of verifying at least one authentication code associated with a user includes accepting an authentication code from at least one of a biometric sample, a secret code, a single factor authentication code, and a multifactor authentication code.

29. The method as claimed in claim 27, wherein the step of facilitating a verified user to generate a notification includes prompting the verified user to enter credentials and geographical data of parties participating in the transaction; specific or range based value for the transaction; time-limit associated with the notification; and compressing and scrambling the composed notification for transmission.

30. The method as claimed in claim 27, wherein the step of storing said notification corresponding to said identification code includes sending a delivery receipt confirmation message back to the computing device for displaying to the corresponding user.

31. The method as claimed in claim 27, wherein the step of verifying an actual transaction based on the notification includes the following steps:
comparing the details of the notification with the details of the actual transaction to verify if actual transaction is within the bounds of said notification; and
marking the notification as used/partly used in the repository and updating the status of the transaction.

32. The method as claimed in claim 27, wherein the step of verifying an actual transaction includes:
generating a reverse notification at the data processing and storage unit in the event that no stored notification is retrieved;
transmitting said reverse notification to a user on the corresponding computing device;
conducting authentication code verification for the user; and
enabling the user to approve a transaction if the authentication code is verified.

33. The method as claimed in claim 27, wherein the method includes registration of users for facilitating authorization of transactions, the method comprising the following steps:
prompting a user to select at least one account associated with at least one entity;
prompting for input of at least one sample authentication code from the user;
prompting the user to select at least one storage preference of said sample authentication code, wherein said storage preference is at least one of in a memory included in the computing device, in the repository of the data processing and storage unit, and a third party storage and verification server accessible to the computing device and the data processing and storage unit;
capturing at least one authentication code from the user; and
verifying said authentication code with said sample to confirm registration and assign an identification code to the user.

34. The method as claimed in claim 27, wherein the step of verifying at least one authentication code associated with a user includes verifying said authentication code with a sample stored in the computing device.

35. The method as claimed in claim 27, wherein the step of verifying at least one authentication code associated with a user includes verifying said authentication code with a sample stored in the repository of the data processing and storage unit and transmitting the verification result to the computing device.

36. The method as claimed in claim 27, wherein the step of verifying at least one authentication code associated with a user includes verifying said authentication code with a sample stored in a third party storage and verification server and transmitting the verification result to the computing device.
